(19) United States
(12) Patent Application Publication
(10) Pub. No.: US 2006/0080286 A1
(43) Pub. Date: Apr. 13, 2006

(54) System and method for storing and accessing images based on position data associated therewith

(75) Inventor: Hugh B. Svendsen, Chapel Hill, NC (US)

Correspondence Address: DANIELS DANIELS & VERDONIK, P.A., SUITE 200 GENERATION PLAZA, 1822 N.C. HIGHWAY 54 EAST, DURHAM, NC, 27713, US

(73) Assignee: FlashPoint Technology, Inc., Peterborough, NH (US)

(21) Appl. No.: 10/930,719

(22) Filed: Aug. 31, 2004

(51) Int. Cl. G06F 17/30

(52) U.S. Cl. 707/3

(57) ABSTRACT

A method and system for providing a network-based photosharing service is disclosed. The photosharing service includes a central photosharing site having a server, and a plurality of peer nodes each containing digital images. The method and system include associating metadata with each image that is to be shared. The metadata is standardized data indicating at least the position where the image was created. Preferably the data is GPS data, but can be from other sources, and is standardized. Storage of the images is maintained on the respective peer nodes. In response to the peer server receiving search criteria based on the metadata submitted from a first one of the peer nodes, the peer server returns a list of image locators for images matching the search criteria to the first peer node. The images are returned in order of accuracy of the position information data source. There is also disclosed a method and system implemented on a single computer.

### FIELD OF THE INVENTION

The present invention relates to electronic storage and sharing of digital images, and more particularly to an improved photosharing architecture based on location, time, and date information associated with the digital images.

### BACKGROUND OF THE INVENTION

Over the past several years, photosharing has become widely accepted by photo enthusiasts. Many websites currently exist that allow users to upload digital images to the site for storage on a server and for viewing by others over the Internet. To share photos, users must first register on a photosharing website, and create an image album in which to store their images. The user typically selects a theme for the image album and selects one or more images to upload to the site from their PC. The images are then uploaded to a server for storage and associated with the selected album. After creating the image album, the user may optionally rename and/or edit each photo.

Metadata, which is typically associated with an image or group or images, is often supported by photosharing sites. This metadata is restricted in that users cannot define new metadata fields or are limited to a fixed number of “user defined” fields. Metadata support usually does not extend much beyond that defined by the Exif image file format standard. Searches are usually limited to only a subset of the limited metadata that is supported by a site.

The user may then notify others of the album using one of two methods. In the first method, the user sets preferences for the album specifying what users have permission to view the album, and personally informs each person of the web address of the album. In the second and more common method, the user types-in the e-mail addresses of each person the user wants to view the album and the photosharing site automatically sends an e-mail inviting recipients to view the album by clicking on the enclosed URL.

Although the current approach to photosharing works for its intended purpose, there are some areas where the traditional server centric photosharing falls short. Those areas include the difficulties users encounter when attempting to upload images to the site, and the cumbersome process of organizing images once on the site. Due to these difficulties, users predominantly store the majority of their images on their local PC, and upload only those images that they really wish to share with others. Because the shortcomings of current photosharing sites force users to store some of their images on their PCs and other images on the photosharing site, the usage model for web-based photosharing is unnecessarily complicated.

Another problem associated with current photosharing websites is the infrastructure cost inherent in hosting such a space intensive application on a single site. Not only do traditional photosharing sites require vast amounts of disk space to store the photos of all their users, but the owners of the websites must also incur the cost of redundant disk space that is used for backup purposes. Based on high infrastructure costs and the increasing number of users, it is believed that most photosharing sites will pass on this cost to users by transitioning from a free service to a monthly subscription fee model. Charging a fee for using photosharing websites may actually inhibit the widespread adoption of such sites.

A number of these problems are solved by the system described in the aforementioned U.S. Pat. No. 6,757,684 which solves both storage and usability problems, and alleviates infrastructure requirements for photosharing.

In more recent developments, as information from around the world becomes more prevalent due to advances in travel and information technologies, it has become desirable to obtain and view images based on the location the image was created, including time, date or even location of the system where an image is stored. In current approaches such as in a system like that described in U.S. Pat. No. 6,757,684, such location based image searches are based on user input of metadata involving user selected descriptions. Thus, for example a user storing images of the island of St. Martin, may input metadata indicating the Caribbean. Another user may enter N.A. for the Netherlands Antilles or D.A. for Dutch Antilles. As may be appreciated, the variability of the metadata may yield diversely varying results. The present invention avoids such variability and provides for reliable and accurate location searching.

### SUMMARY

The present invention is a method and system for providing a network-based photosharing service. The photosharing service in one aspect includes a central photosharing site known as the peer server, and a plurality of peer nodes each containing digital images. The method and system include associating metadata with each image that is to be shared. The metadata is made up of standardized position information about the location of where the images were taken. Such position information is in one aspect preferably Global Positioning System (GPS) data including longitudinal and latitudinal coordinates, and optionally date and time information. The images are shared by uploading the metadata associated with each image from the peer nodes to the peer server, while maintaining storage of the images on the respective peer nodes. In response to the peer server receiving search criteria based on the metadata submitted from a first one of the peer nodes, the peer server returns at least one image locator for at least one image matching the search criteria to the first peer node. The method and system further include dynamically generating on the first peer node an image album that contains at least a portion of the matching images.

It will be appreciated that reference is made to at least one locator and at least one image because GPS data is very precise. Thus, depending on the variability set for the search in terms of position range, it is possible that no images are identified, for example, when an exact longitude and latitude are selected. On the other hand, as the search expands to a range of longitudes and latitudes, the resulting list of images may expand. The user may then select an image located closest to the originally selected position and conduct further searches from that point on.

In accordance with a new and more specific implementation, there is described a distributed environment peer system in which the peers host digital images stored with metadata which also includes date, time and position information. In the system, an electronic album may be constructed to hold collection of images taken at many different times, places (positions) and dates. The metadata is, as noted, preferably standardized by GPS data for positions associated with the image. Owners of a peer system may invite others to view the contents using a web browser or other like software which provides appropriate functionality.

In a preferred aspect, when an image is presented as a result of a position or time search, the display also includes two other buttons. A first button is for selecting a display of other images taken at about the same place, date and time as the original image. These images may reside in the user's own computer or on a peer in the network. The user may limit the selection to specified computers or to the user's own computer.

A second button shows a user a map of the world showing the position at which the picture, and a timeline showing when the picture was taken.

In a further and yet still more specific aspect, the invention can be implemented on a single computer, outside of a network with the aforementioned options all being available, and confined to one user's computer.

In a yet still further aspect of the invention, although GPS data is preferred for position information for images, other sources can be used to obtain position information which can be applied to images. The information can be later searched, and is stored in GPS format, irrespective of the source. When a user conducts a search however, if multiple images are returned with the same GPS coordinate, the system returns the image that was positioned with the most accurate system. If a GPS receiver was one of the positioning technologies used, the GPS positioned image will be returned first.

### BRIEF DESCRIPTION OF THE DRAWINGS

FIG. 1 is a block diagram illustrating a network-based photosharing system in accordance with a preferred embodiment of the present invention.

FIG. 2 is a block diagram illustrating the peer node application software.

FIG. 3 is a block diagram illustrating the contents of the central site peer server.

FIG. 4 is a diagram illustrating relationship between metadata schemas that are stored in the metadata repository and the actual metadata and images.

FIG. 5 is a flow chart illustrating a registration and installation process for a user to sign up with the network-based photosharing service.

FIG. 6A is a flow chart illustrating in further detail the synchronization process between the peer demon and the peer server (step 114 of FIG. 5).

FIG. 6B is a flow chart illustrating the handling of pending requests when a peer node comes back online and has registered with the peer server.

FIGS. 7A-D are flow charts illustrating the process of a user uploading image metadata to the peer server using the peer node software.

FIGS. 8A-C are flow charts illustrating the process of creating and managing an image album on a peer node.

FIG. 9 is a screen shot showing an image displayed and selection criteria based on peer, position proximity, and time for finding other images.

FIG. 10 is a screen shot showing other images on the peer network created in proximity in time and position in relation to referenced image.

FIG. 11 is a screen shot of the position and time an identified image was created.

FIG. 12 is a screen shot showing other peers positioned within a selected distance from the same position the image was captured.

FIG. 13 is a screen shot showing selection of other peers on the network positioned at about the same position as the current peer.

FIG. 14 is a block diagram showing various position information sources, and the typical data layout of an image having information from various position sources associated therewith.

### DETAILED DESCRIPTION OF THE INVENTION

In one aspect, the present invention relates to a method and system for providing a web-based, peer-to-peer photosharing service. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown but is to be accorded the widest scope consistent with the principles and features described herein.

There is described an improved network photosharing service that solves storage problems encountered by photosharing service providers and also solves photo sharing usability problems encountered by users of the service. The system provides a web-based, peer-to-peer photosharing service in which all workstations and computers in the network store their own images and act as servers to other users on the network. A central server, known as the peer server, is provided that stores metadata about all of the images and provides users with a search capability to find images of interest. In a specific implementation, the metadata associated with the images is date, time and position data, for example, as created with a combination digital camera and global positioning sensor (GPS) device.

In a further development, the other sources can provide the position information. The information is applied to the images and is stored in GPS format, irrespective of the source of the information.

As noted, the most preferred position information is obtained via GPS receiver which can be attached to a camera or a laptop computer. The GPS receiver communicates with satellites to triangulate the position of the device, and is accurate to about 50 feet.

As an alternative, cell phone towers positioning can be used. A camera built into cell phones is adapted in a manner well known to those of ordinary skill in the art to take advantage of the positioning information required for cell phones. More specifically, all carrier/handset manufacturers are required to be able to locate handsets to within 100 feet of actual location. Such systems are currently implemented in tower only, as well as GPS assisted tower configurations.

A still further and less accurate alternative are geo-positioning services for networks. More specifically, devices such as cameras, laptops, or cell phones connected to the Internet have an IP address. Such devices can be positioned through geo-positioning services which at this stage are generally accurate to a city level. For many applications this level of accuracy may be sufficient.

User positioning is also possible. A camera or computer storing images may be configured to present the user with a map of the world. The user can be allowed to click on a series of maps and zoom into the user's location. The user then selects a Final location and the position of the location is stamped into the image.

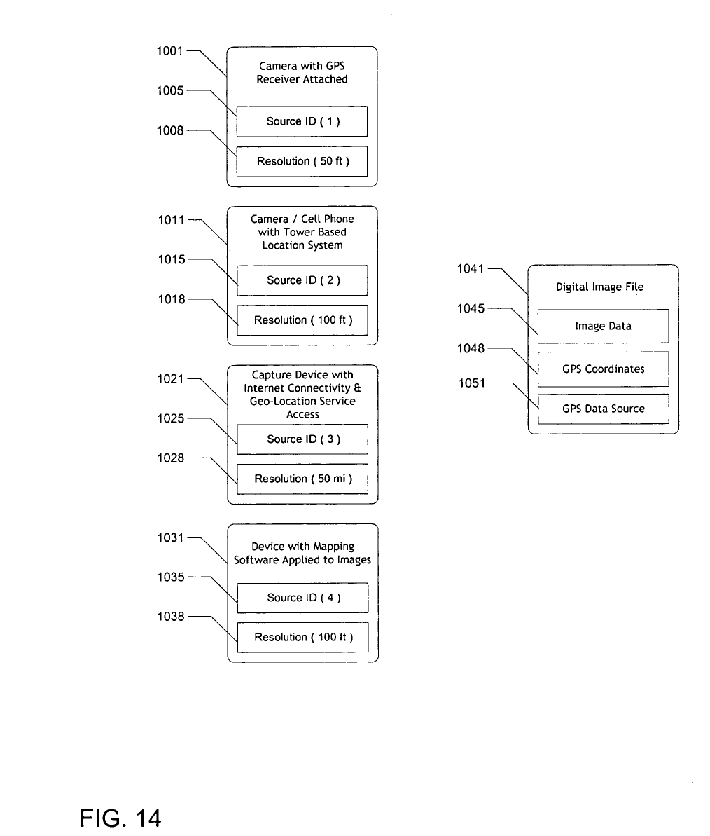

The various position data options are illustrated in greater detail in FIG. 14, discussed hereafter.

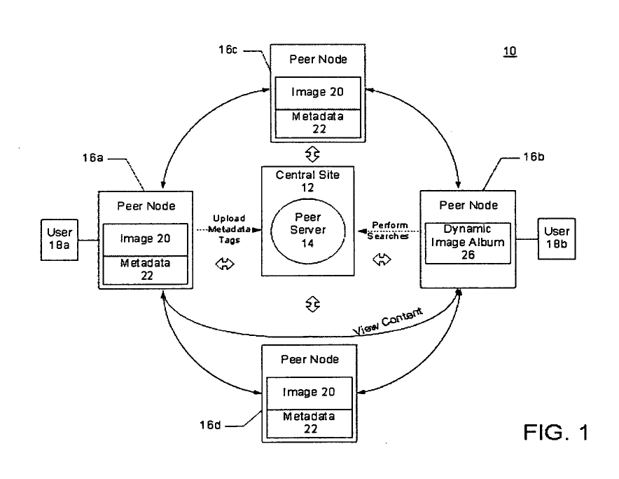

FIG. 1 is a block diagram illustrating a peer-to-peer (P2P) photosharing system in accordance with a preferred embodiment of the present invention. The system 10 includes a central photosharing website 12 that includes a peer server 14, and multiple peer nodes 16. The peer server 14 and each of the peer nodes 16 are capable of communicating with one another over a network, such as the Internet. In a preferred embodiment, users 18 may also access the central site 12 from devices or clients (not shown) that are not peer nodes 16, via the use of a standard web browser.

In one embodiment, the peer nodes 16 may each represent either a website or a computer, and typically store the digital images 20 of a particular user 18. A peer node may store the images of more than one user. For example, two family members who share a home PC, but manage their images separately may maintain separate accounts with the system 10 on the shared PC. The digital images 20 are stored as image files that include image data. Each image also has metadata 22 associated with it that describe and categorize the image. The metadata 22 may be associated with the images 20 by the user 18 or automatically by the peer node 16 as described below. In addition some or all of the metadata 22 may be associated with the image by a digital camera at the time of image capture. This metadata 22 is preferably generated by a GPS device indicating time, date, and place the image was captured. In addition, the IP address of the computer on which the image resides can provide additional position information about the city the image is stored. Each image 20 may also be associated with a particular type of metadata, which is a smaller representation of the image data, called a thumbnail image 24.

While a GPS device and GPS data is one example of the type of data associated with the image, as already discussed, it is also possible other types of data may be used so long as it is standardized and avoids variability in description depending on user selection or schema variation. For example, as an alternative, if GPS is not used, other types of position information techniques can be used, and the data stored in GPS format as position information irrespective of the source as previously discussed.

As in U.S. Pat. No. 6,757,684, this is in contrast to the traditional photosharing model where the user 18 posts digital images by uploading the images from his or her computer to a webserver for storage in a static album. Instead, in the present invention, the peer nodes 16 maintain storage of the actual image data and only the metadata 22 (and, in particular, the thumbnail image 24) for each image are uploaded to the peer server 14. Users 18 of the peer nodes 16 register themselves and their peer nodes 16 with the peer server 14 to become members of the service so that other users 18 can search for and view their images 20. The peer server 14 maintains a list of users 18, a list of groups to which users may belong, and peer nodes 16, and provides a search engine and a cache of the time, date and position metadata for each shared image and for the location of the peer on which the image is located.

According to a further aspect, users 18 may dynamically create image albums 26 for viewing the images 20 by submitting search criteria that are based on the time, date and position metadata 22. In FIG. 1 for example, user 18a has shared images 20 on the central site 12 by uploading the metadata 22 to the peer server 14. User 18b may then submit a search to the peer server 14 to view images 20, which match the search criteria.

In response, the peer server 14 returns at least one and possibly a list of image locators (e.g., URLs) for images 20 matching the search criteria to peer node 16b. In one aspect, the search is based on the standardized position data which can be GPS, cell phone tower positioning, geo-positioning for user entered previously discussed. In a preferred method, the images corresponding to the most accurate is returned first and/or down to the least accurate. The user 18b then selects at least one entry on the list, if one is returned corresponding to the images to be contained in the album 26. In a preferred embodiment, the user 18b is shown at least one or a list of thumbnail images with some subset of metadata which identifies the image and/or its source, rather than a list of image names. In an alternative embodiment, peer node 16b may display the list of peer nodes 16 with matching images before retrieving any image data and/or additional metadata, and allow the user to select which peer nodes 16 to use in composing the album.

After the user 18b makes his or her selections from the list, the peer node 16b sends requests using the image locators to retrieve the matching images as needed.

The handling of the requests depends on where the images are being retrieved from. There are three cases: 1) one or more of the selected images are stored on the requesting peer node, 2) one or more of the images are stored on a peer node that may or may not be online at the time, and may or may not have a reachable network address, and 3) the request is for thumbnail images, which are stored on both the peer server 14 and the peer nodes that shared the corresponding images.

If one or more of the matching images are stored on the requesting peer node 16b, then the images are retrieved from the requesting peer node 16b for incorporation into the album 26. If one or more images are stored on another peer node 16 that is online and has a network address which is reachable from peer node 16b, then the image locators returned from the peer server 14 direct the peer node 16b to the other peer node 16 for retrieval of the images. In a preferred embodiment, the image locators returned by the server to the peer node 16b indicate which nodes are currently online so that the peer node 16b can send the URL request directly to the corresponding peer nodes 16 without first sending the request to the peer server 14.

If one or more images are stored on another peer node 16 that is currently offline, or does not have a network address which is reachable from peer node 16b, the image locators are modified to route the request for the images back to the peer server 14, which in the case of a firewall, acts as a proxy for the peer node 16. After becoming a proxy, the peer server 14 routes the image requests and responses appropriately. If the album 26 that is to be generated includes thumbnail images, which are part of the time, date and place metadata that is uploaded to the peer server 14, then the server 14 returns the thumbnails directly to the peer node 16b, eliminating the need to retrieve the thumbnails from other peer nodes 16.

It will be appreciated that the invention in an alternative aspect can be implemented in a single computer not connected to a network. In this case, the date, time and position metadata would be stored in association with images all on a single computer. In all other respects, the storing, searching and manipulation would be conducted as otherwise described herein in a peer-to-peer network. Date and time data is fairly easy to standardize. The position metadata is preferably based on GPS data from a GPS device associated with the digital camera with which the image was captured.

As the peer node 16b receives the responses, the peer node 16b aggregates the responses to produce a view of the album 26. In a preferred embodiment, peer node 16b composes one or more web pages which user 18 is able to view in a web browser. Peer node 16b may retrieve the presentation components such as graphic art, page templates, and so on from peer server 14 as needed. Peer node 16b may cache presentation components retrieved from the peer server 14 for future use to enhance performance.

According to one aspect of the system, image albums 26 are not statically defined as they are traditional photosharing sites. Instead albums 26 are defined by search criteria, which are at least based on position data, and optionally the date and time metadata 22. The position data is preferably GPS data for the position, and may optionally also include position metadata based on the IP address of selected peers, and generated on the user's peer node in real-time using not only the user's own images 20, but also the images 20 of other peer nodes. In any event, the data should be standardized as to position and may be of various types as previously discussed. In the event of where the position data was created in the preferred criteria, the images tagged with the most accurate data will be returned first. The albums 26 created as a result of the searches and/or the search criteria may also be saved. They may be saved as search criteria or as the result from the initial search criteria subject to the preferences of the user. The peer-to-peer photosharing system 10 of the present invention has several advantages over traditional photosharing, including:
significantly reduced image upload time, since images 20 are stored locally,
search capability for all images in the system,
the user retains control over locally stored images,
dramatically reduced infrastructure requirements for the photosharing site, and
highly scalable infrastructure.

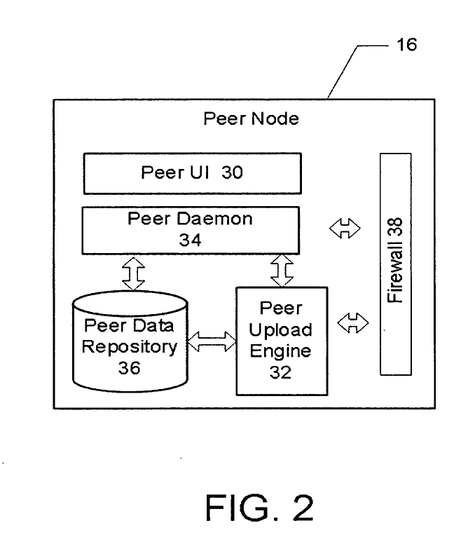

FIG. 2 is a block diagram illustrating the peer node 16 application software. In a preferred embodiment, a peer node 16 application software includes a peer user interface (UI) 30, a peer upload automation engine 32, a peer daemon 34, and a peer data repository 36. The peer node 16 may also include an optional firewall 38 or access the Internet through a firewall located in another device.

The peer UI 30 is a graphical user interface application that allows the user 18 to view and edit data. The data in most cases is images 20 and associated metadata, which may reside on both the peer node 16 or on remote peer nodes 16. Although the peer UI 30 may be implemented in a number of different ways, in a preferred embodiment the peer UI 30 is implemented as a web browser but alternately it may be an application specifically designed for the system 10.

According to a first aspect of the present invention, the peer daemon 34 automatically assigns metadata 22 to the images 20 prior to the metadata upload process. The peer daemon 34 makes intelligent guesses at how to fill-in the metadata values 22 using defaults specified by the metadata schemas. In addition, the peer daemon is trained over time based on the user's past behavior. The peer daemon 34 then makes use of the peer upload automation engine 32 to send the metadata 22 associated with the images to the peer server 14. The metadata facilities of the peer daemon 34 and peer upload engine 32 allow a user 18 to categorize and upload the metadata 22 for a very large number of images 20 to the peer server 14 with ease. The peer daemon 34 also allows the user 18, to make simple edits to the pictures before the images 20 are stored and the metadata 22 is uploaded (rotation for example). In the alternative, the metadata may remain at the peer and peer-to-peer searching by metadata is conducted.

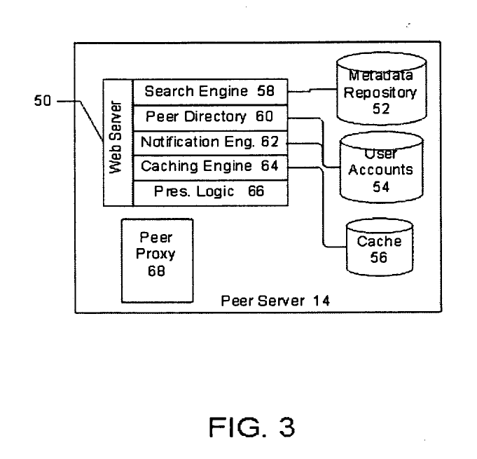

The peer daemon 34 includes a background process that scans the peer node 16 computer for images 20 that are to be shared, and catalogs metadata about images 20. The peer daemon 34 uses the peer data repository 36 to store images 20 and local copies of the metadata 22. In a preferred embodiment the peer daemon 34 acts as a web server to present the peer UI 30 to the user through a web browser. The peer daemon 34 communicates with the peer server 14 as needed to retrieve presentation components as needed, thus distributing the presentation logic of the system. In a similar manner, the peer daemon 34 may also offload other work from the peer server 14 that is typically the sole responsibility of a central server or site in a traditional photosharing server. Examples of such work activities, include caching and processing of security information, receiving and routing events, acting as a peer proxy 68 for other peer nodes (see description of FIG. 3), and caching user and group account information.

FIG. 3 is a block diagram illustrating the contents of the central site peer server 14. In a preferred embodiment, the peer server 14 includes a web server application 50, optionally a metadata repository 52, a user and group account database 54, a cache 56, and a peer proxy 68.

The web server application 50 serves pages formatted to suit the capabilities of the client device so that a standard web browser can be used to view the data returned by the web server.

The metadata repository 52 is a database that stores metadata definitions and the metadata 22 uploaded from peer nodes 16 associated with specific images and groups of images 22 associated with images 20 stored on the peer nodes 16. This metadata 22 definition may be in addition to the specific date, time and position metadata 27 which was generated, for example, by a GPS device. In a further embodiment, some of the additional metadata definitions may be specified using the W3C Resource Definition Framework (RDF) standard as described in U.S. Pat. No. 6,757,684. In that patent a core metadata schema/vocabulary is defined, which is associated with all images. Groups and users may specify their own metadata 22 vocabularies and may share these vocabularies with other users and groups in addition to the date, time and position, as well as position of where the image is stored based on the IP address of the peer. Users and group administrators may specify one or more vocabularies, which are supported for images associated with the user and group accounts, respectively. The peer server 14 and peer nodes 16 enforce these metadata requirements.

The user account database 54 may be used to store user account and corresponding contact information and preferences of each registered user 18. Groups of users may also share common policies, which may include permission settings, UI options, required and optional metadata vocabularies, subscriptions lists, event/notification policies, and caching policies.

The cache 56 is used to store the metadata 22 associated with frequently accessed images 20 to provide for quicker searches. The metadata 22 may be automatically replaced in the cache 56 with the metadata 22 from other images 20 based on the peer server's configured caching policies. The peer proxy 68 allows the peer nodes 16 behind firewalls 38 to connect with peer server 14. Once this connection is established other peer nodes 16 may contact the associated peer node 16 behind a firewall 38 by connecting to the peer proxy which will route requests to the peer node behind the firewall and will route responses to the associated node making the request.

The peer server 14 further includes a search engine 58, a peer directory 60, an event/notification engine 62, a caching engine 64, and presentation logic and resources 66. The search engine 58 takes requests received by various peer nodes 16 and searches through the metadata 22 stored in the metadata repository 52. The search engine 58 also has the capability of offloading searches by passing the search criteria to one or more of the peer nodes 16 to search the metadata 22 stored on the peer node(s) 16. In one embodiment, the peer site offloads searches to peer nodes 16 with large amounts of metadata 22. An example of such a peer node 16, is a peer node 16 which is also a traditional centralized photosharing site.

The peer directory 60 maintains a list of active peer nodes 16 and associates the peer nodes 16 with registered users 18 from the user account database 54. The notification engine 62 is responsible for notifying peer nodes 16 when predefined events occur. Examples of predefined events include other peer nodes 16 becoming active, particular images 20 being posted on the peer server 14, or a request being filled. The caching engine 64 interfaces with the cache 56 and is responsible for determining what data to cache, where to cache it, and how long to hold the data.

The presentation logic 66 composes the user interface for user interaction with the peer site. The presentation 66 logic also provides templates and presentation resources (e.g., icons, graphics) used by the peer nodes in composing user interface elements. The presentation logic 66 adapts the presentation based on the capabilities of the requesting device and user 18 preferences as further illustrated hereinafter with reference to FIGS. 10-13.

The peer server 14 may also provide the peer nodes 16 access to external service providers (not shown), which may include print fulfillment providers, or services that burn image albums 26 on CDs or prints real album pages, for instance.

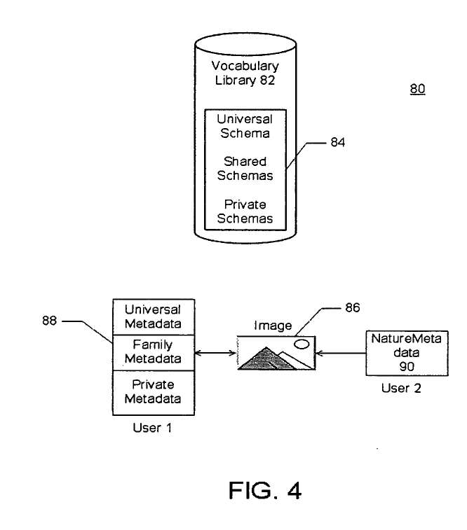

FIG. 4 is a diagram illustrating some metadata definitions 80, which are stored in the metadata repository 52. According to the present invention, the system 10 may provide a vocabulary library 82 for storage and management of metadata schemas 84 or vocabularies. In a preferred embodiment, the vocabulary library 82 includes a universal schema, shared schemas, and private schemas, which may be defined using RDF and XML. All images 20 in the system 10 may have associated with them metadata 22 specified by the universal schema, in addition to the required position metadata, for example, GPS data. Of course, while GPS data is preferred, as previously discussed, other types of position data can be used as illustrated in FIG. 14. Date and time, as well as place of storing peer metadata 22 may also be preferably specified. Optionally, position of the hosting peer based on IP address is also associated with the image. Users 18 and groups may also define their own additional schemas, which may include the universal schema and may borrow from other vocabularies as RDF and XML allow.

As an example, assume that an image 86 of a family with mountains in the background has been added to the system 10 by a user 18a. User 18a has defined a private schema 88 that includes the universal schema, may borrow from a shared schema defined for family metadata, and add additional metadata for the user 18a's private use. User 18b has discovered image 86, perhaps through a search using fields in the universal schema. Seeing the mountains in the picture and being an avid fan of nature photography user 18b creates nature metadata 90 to associate with image 86 using a shared schema defined for nature photographs. User 18b has uploaded this metadata 90 for the image to the peer server 14. Other users constructing searches built using one or more of the vocabularies (universal, family, user 18a's private extensions, and nature) will be able to find image 86 if the search criteria match. The schema definition 84 is not limited by the system 10. Further, there is no theoretical limit to the number of separate instances of metadata 22 which could be provided and associated with images 20. Note that it is user 18a's option to share the private schema extensions and the private metadata. User 18a may send the private schema specification to the peer server 14 allowing others to construct searches using the private vocabulary. The peer server 14 will require user 18a's peer node to perform the actual search if the actual metadata has not been stored on the peer server 14. As may be appreciated, the addition of place metadata such as COPS location data, provides greater and more precise search capability.

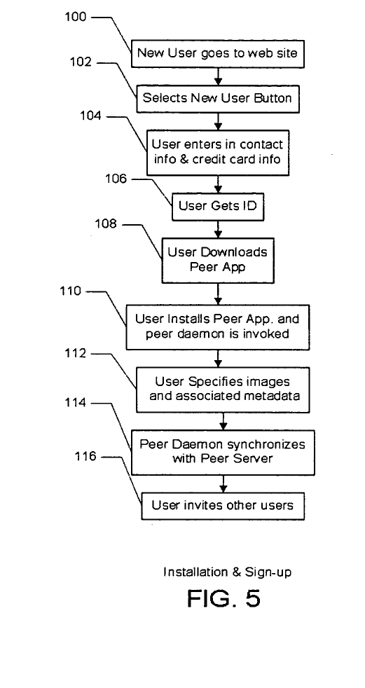

In operation, the user 18 first installs peer software on his or her computer to create a peer node 16 and signs-up for the service. The user 18 may share images 20 that are local on the user's peer node 16 with the photosharing site 12 by uploading the image metadata 22, thus synchronizing the peer node 16 and the peer server 14. To view the data, the user 18 may select predefined albums 26 to view for which he has the necessary permissions or user 18 may submit a search, which results in the creation of dynamic image albums 26 that display the images 20 matching the search criteria. These process steps will now be explained in further detail with reference to FIGS. 5-8.

FIG. 5 is a flow chart illustrating an installation and registration process. The process begins with an Internet user 18 visiting the peer server website is in step 100. The user 18 clicks on a new user button, and is directed to a page for signing up for the peer-to-peer service in step 102. The user 18 enters the required signup information on a sign-up page in step 104. In response, the user 18 obtains a unique peer ID that will be used to identify the user peer node 16 in step 106.

After becoming a registered user 18, the user 18 downloads the peer node application software 16 in step 108. After downloading the peer node software 16, the user 18 installs the peer node software 16 and invokes the peer daemon 34 in step 110. The user 18 is then given the opportunity to specify images 20 and associated metadata 22 including date, time, position and position of peer storing the image that may be shared using the system 10 in step 112. The peer daemon 34 automates as much of the process of providing metadata 22 as is possible by providing default values for the required data in the required schemas for the user 18. In the preferred embodiment of the invention, the only required data is the data specifying position, the image was created, for example, preferably through GPS data associated with the image. The user is given the opportunity to add other values such as date and time, as well as position of the storing peer based on its IP address. Alternatively, the data and time are added automatically, such as from software resident in the digital camera capturing the image.

In one optional embodiment, the peer daemon 34 then synchronizes with the peer server 14 and uploads the metadata 22 in step 114. After the image metadata 22 has been uploaded, the user 18 may invite others registered users 18 to visit the site in step 116. The user 18 may invite non-registered users by providing their email addresses. The non-registered users may be sent emails inviting them to register with the peer server 14 after which they may view the user's 18 images.

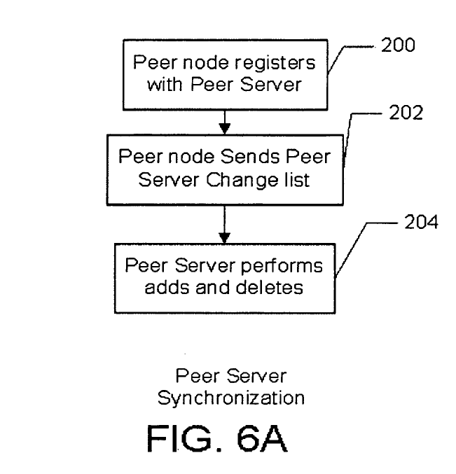

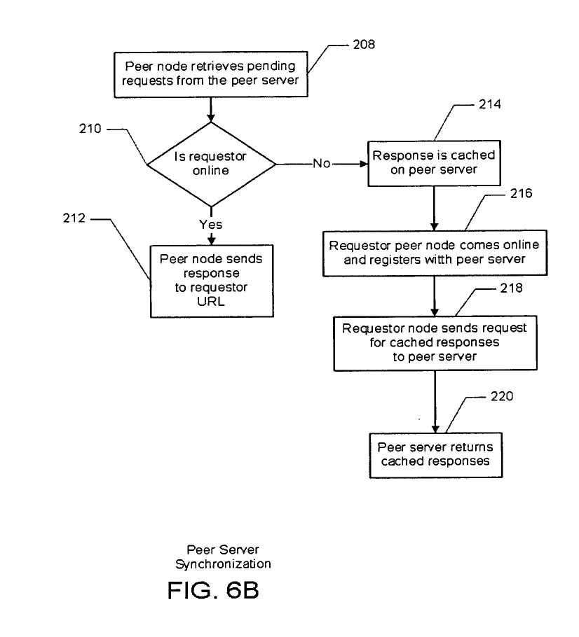

FIG. 6A is a flow chart illustrating in further detail the synchronization process between the peer daemon 34 and the peer server 14 as described in step 114 of FIG. 5. This process occurs when the peer node 16 is initiated and when initiated by user 18 additions, deletions, and changes while online. FIG. 6 describes this process in terms of peer node initiation. After the peer node 16 has been initiated, the peer daemon 34 registers with the peer server 14 in step 200. Optionally, after registration, the peer upload engine 32 sends the peer server 14 a change list in step 202 specifying the metadata, in particular position data such as GPS data, for images 20 the user 18 wishes to share on the photosharing site 12 as well as those that the user 18 wishes to delete or has modified. The peer server 14 then updates the metadata repository 52 to reflect which images 20 have been added, modified, and which have been deleted in step 204.

The system 10 allows requests to be made for images 20 on peer nodes 16 that are offline at the time the request is made. FIG. 6B is a flow chart illustrating the handling of pending requests when a peer node comes back online and has registered with the peer server. When the peer node 16 comes online, the peer node 16 sends a request to the peer server 14 to get any pending requests for images that are stored on the peer node 16 in step 208. In the case where the options of FIGS. 5 and 6 are implemented, each request for an image includes a URL indicating where to send the response. Once the pending requests are received by the peer node 16, the peer node 16 processes each pending request. The response must be handled differently depending on whether the requesting peer node (requester) is currently online or not. In a preferred embodiment this decision is handled at the peer server in step 210.

If the requestor is online in step 210, the peer node 16 sends the response to the requestor as indicated by the URL in the request in step 212. If the requestor is not online, then since the peer server 14 tracks the peer nodes 16 that are online, the peer server 14 substitutes the requestor's URL in the request with one of its own prior to sending the pending request to the peer node 16 during step 208. When the peer node 16 subsequently processes the request, the response is sent from the peer node 16 to the peer server 14, as indicated by the URL in the request, where it is cached in step 214. When the requestor comes back online in step 216, the requestor then requests the cached response from the peer server 14 in step 218. The peer server 14 then routes the cached response to the requester in step 220.

Note that the processes illustrated in FIG. 6A and FIG. 6B may be executed on separate threads by the peer node 16, so that the user 18 of peer node 16 may interact with the peer node 16 immediately upon peer node initiation without having to wait for synchronization to complete.

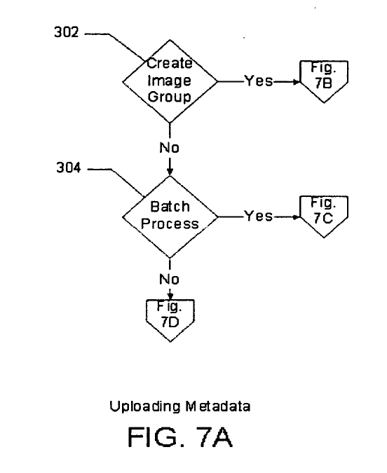

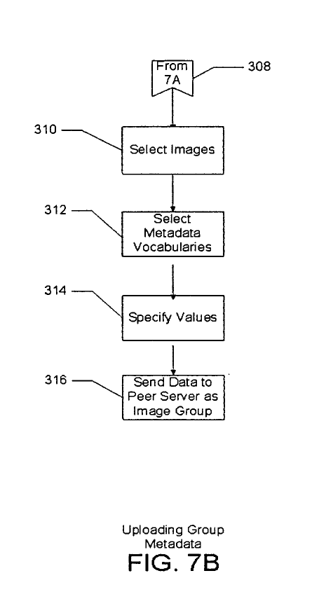

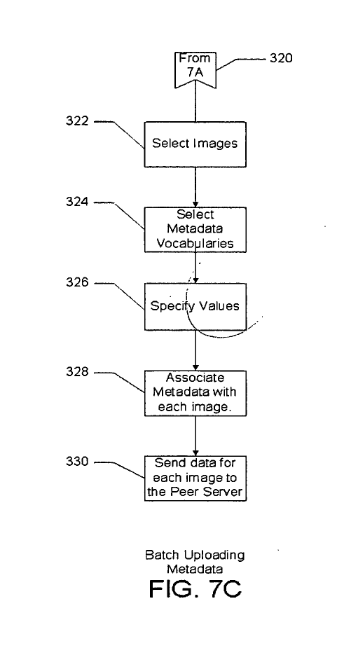

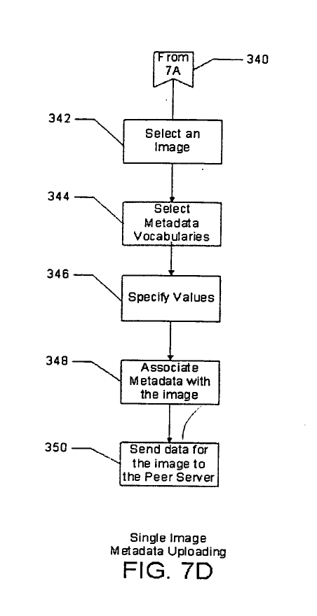

In the embodiment where a user uploads image metadata to a peer server, FIGS. 7A-D are flow charts illustrating such a process using the peer node software. The user 18 first must choose whether to specify metadata 22 for an image group in step 302, to specify metadata 22 for a batch of images not in a group in step 304, or to specify metadata 22 for images 20 individually in steps 302 and 304. Note these choices are not mutually exclusive. That is, an image 20 may be part of any image group and thus have group metadata 22 associated with it. The same image may also have metadata 22 associated with it alone apart from other images 20 in the group.

FIG. 7B illustrates one process of providing metadata for an image group. The user 18 first selects images 20 that are to be associated with the group in step 310. The user 18 then selects which metadata vocabularies to use in step 312. The vocabularies are retrieved from the peer server's 14 vocabulary repository 82 and/or from private vocabularies stored on the peer node 16 only. The user 18 may use the vocabularies as is or combine elements of them to create a new vocabulary. The user 18 may accept the default values provided by the system or override them in step 314. The peer node 16 then sends the data to the peer server 14 as metadata 22 associated with a new image group in step 316.

In a further aspect according to the invention, the metadata 22 is already associated with the image as standardized information, for example, as GPS generated metadata. There may also be time and date data associated, generated by software in the image capture device. The user may then also specify if metadata 22 is to include position of storing peer based on IP address of the peer.

FIG. 7C illustrates the process of providing metadata for images in batch mode. This differs from group metadata in that once the metadata 22 is provided, it is associated with each image 20 separately. The images 20 are not part of an image group with respect to this metadata. It is simply a convenient way to enter metadata for a set of images that share the same vocabularies and many of the same values. The user 18 may follow-up this process by modifying selected data items for each image 20 where the data should vary among images. The user 18 first selects images 20 that are to be associated with the metadata 22 in step 322. The user 18 then selects which metadata vocabularies to use in step 324. The vocabularies are retrieved from the peer server's 14 vocabulary library 82 and/or from private vocabularies stored on the peer node 16 only. The user 18 may use the vocabularies as is or combine elements of them to create a new vocabulary. The user 18 may accept the default values provided by the system or override them in step 326. The peer node 16 then creates separate metadata and associates it with each separate image 20 in step 328. Finally, the peer node 16 sends the metadata 22 for each image 20 to the peer server 14 in step 330. As in the case with the image group metadata 22, there will also be automatically associated metadata such as from a GPS system and associated date and time software on the image capture device or on the COPS system.

FIG. 7D illustrates the process of providing metadata for an individual image. This process is a special case of batch mode processing where the number of images to process is one. In addition to the place metadata, and optionally date and time, the user may select the image 20 that is to be associated with additional metadata 22 in step 342. The user 18 then selects which metadata vocabularies to use in step 344. The vocabularies are retrieved from the peer server's 14 vocabulary library 82 and/or from private vocabularies stored on the peer node 16 only. The user 18 may use the vocabularies as is or combine elements of them to create a new vocabulary.

The user 18 may accept the default values provided by the system 10 or override them in step 346. The peer node 16 then creates metadata 22 and associates it with the selected image 20 in step 348. Finally, the peer node 16 sends the metadata 22 for the image 20 to the peer server 14 in step 350.

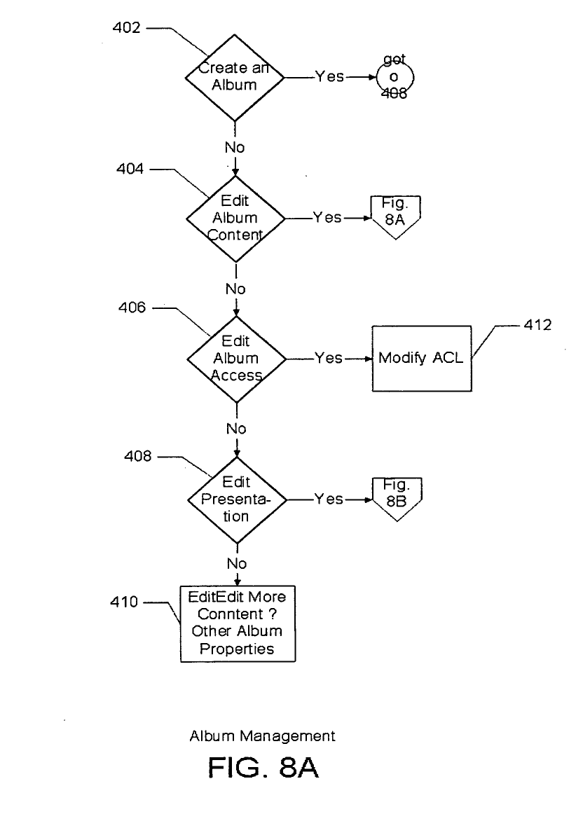

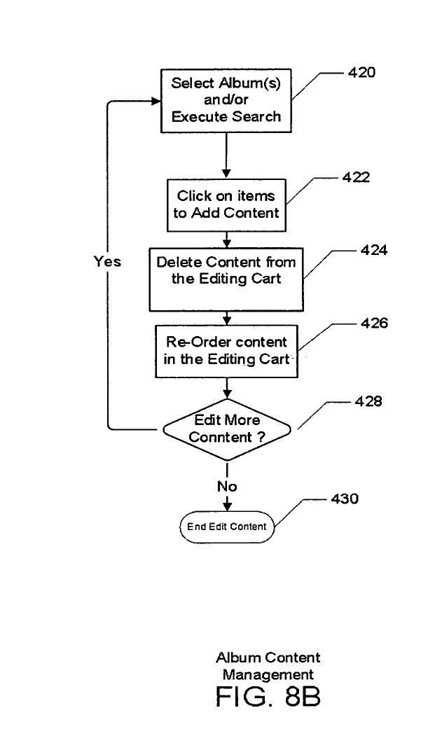

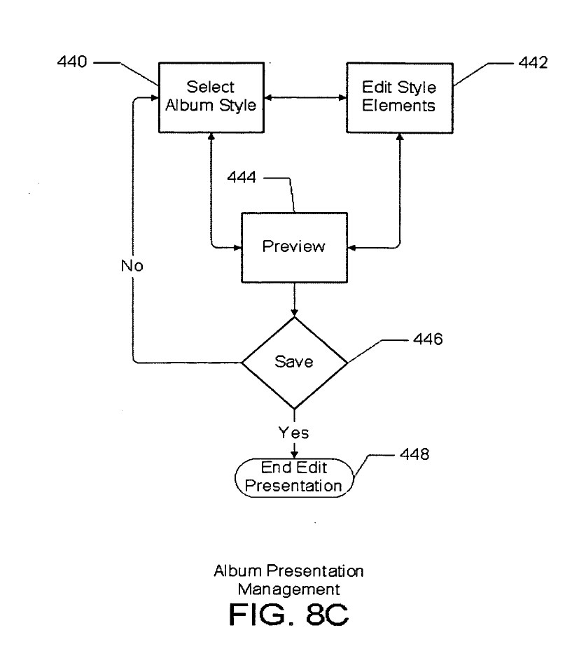

FIGS. 8A-C are flow charts illustrating the process of creating a dynamic image album on a peer node 16. FIG. 8A illustrates the basic choices available to a user 18 for managing albums. A user 18 may choose to create an album 26 in step 402. If the user 18 chooses to create an album 26, the user 18 is prompted to enter certain required information such as the album's 26 name. Once an album 26 exists, the user 18 may edit the contents of the album in step 404, edit access rights to the album 26 in step 406, edit the presentation attributes of the album 26 in step 408, or edit other album attributes (not shown). In a preferred embodiment, access rights management in step 412 is preformed by managing access control lists (ACLs), but may take other forms such as the model supported by the Java Authentication and Activation Services framework.

FIG. 8B illustrates the process of managing the content of an album 26. The user 18 chooses images for the album 26 by selecting one or more albums previously defined in step 420. They may be albums 26 owned by the user 18 or shared with the user. As an alternative or in addition to choosing images from existing albums 26, the user 18 in step 420 may construct a search. The user 18 then selects images 20 from the selected albums and/or searches to be contained in the album 26, and the selected images 20 are placed in the editing card for the album 26 in step 422. The user 18 may delete images 20 from the editing cart of the album 26 in step 424, and may specify the order of the images 20 in the display by modifying the order of the images 20 in the editing cart of the album 26 in step 426. The user 18 may choose to repeat this process in step 428, until finished in step 430.

FIG. 8C illustrates the process of managing the presentation attributes of the album. The user 18 selects from a list of predefined presentation styles in step 440. The user 18 may then either preview the album 26 in the selected style in step 444 or modify style elements of the selected style in step 442. The user may repeatedly navigate through steps 440, 442, and 444 as needed until the user 18 is satisfied with the presentation of album 26. The user 18 then saves the presentation attributes for the album 26 in step 446 (and may save them as a new named style for later use, or to share with others), and finishes management of the presentation of album 26 in step 448.

There has now been described the general invention as implemented in the peer-to-peer system of U.S. Pat. No. 6,757,684, and in improvements thereof as described in application Ser. No. 10/854,084 the disclosure of which is incorporated by reference herein.

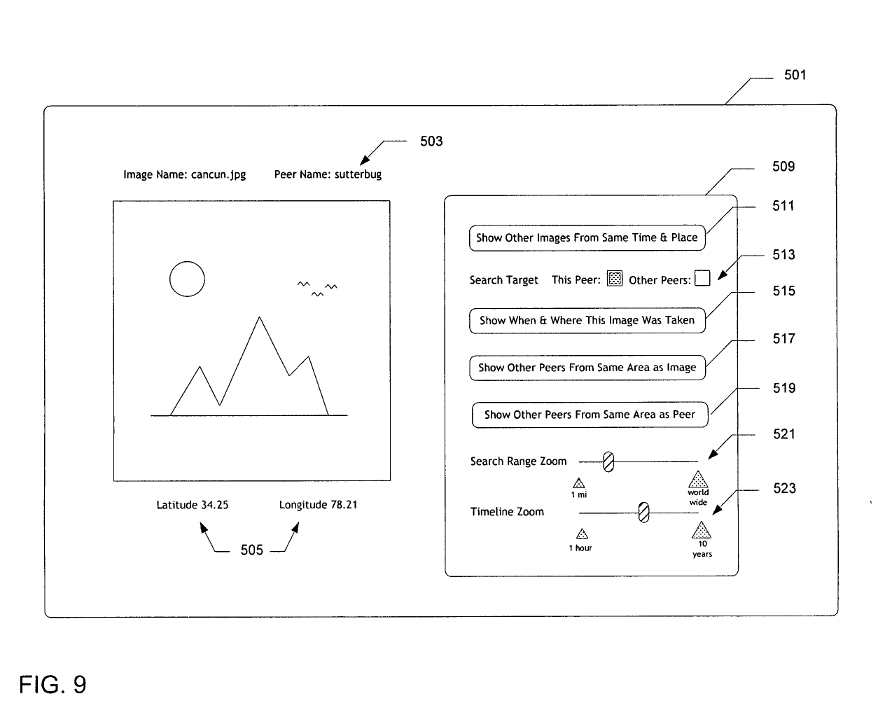

In accordance with the invention certain unobvious improvements relating to position data, as already discussed and further illustrated, are provided. Such improvements include position (preferably GPS) information, time and date, and optionally position of peer storing the image. Of course, as already discussed the position information can come from other sources. In accordance with the invention, results are returned in priority of the accuracy of the position information source, with the default being that the most accurate is returned first. The use and association of images having at least position metadata associated therewith, and optionally date, time and location of storage peer is further described herein in greater detail in connection with FIGS. 9-13.

FIG. 9 is a screen shot 501, for example, on a display, illustrating an image 503 displayed with position information 505, and selection criteria 511-523 in a separate window 509 for finding other images either on the same computer or on peer computers on the peer-to-peer network.

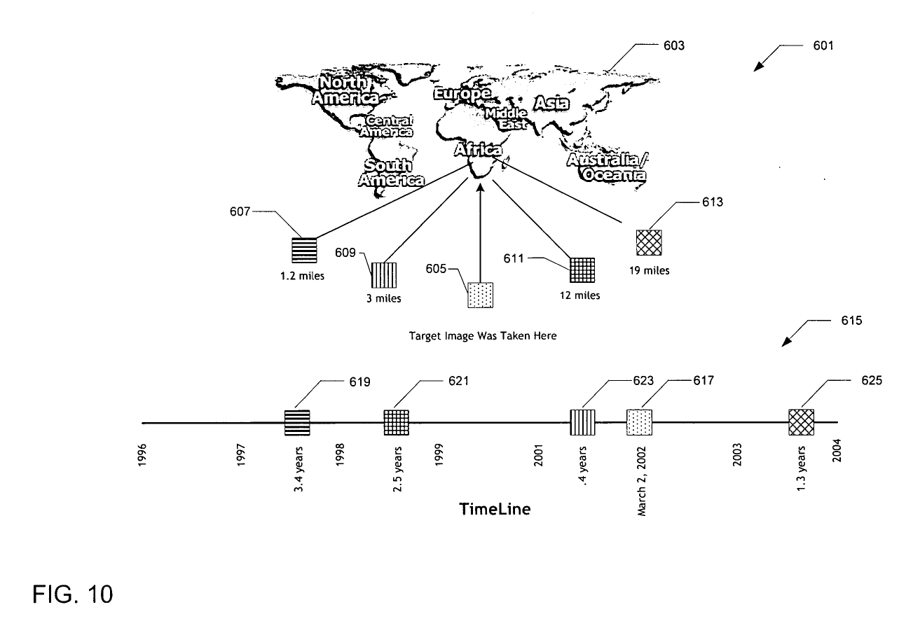

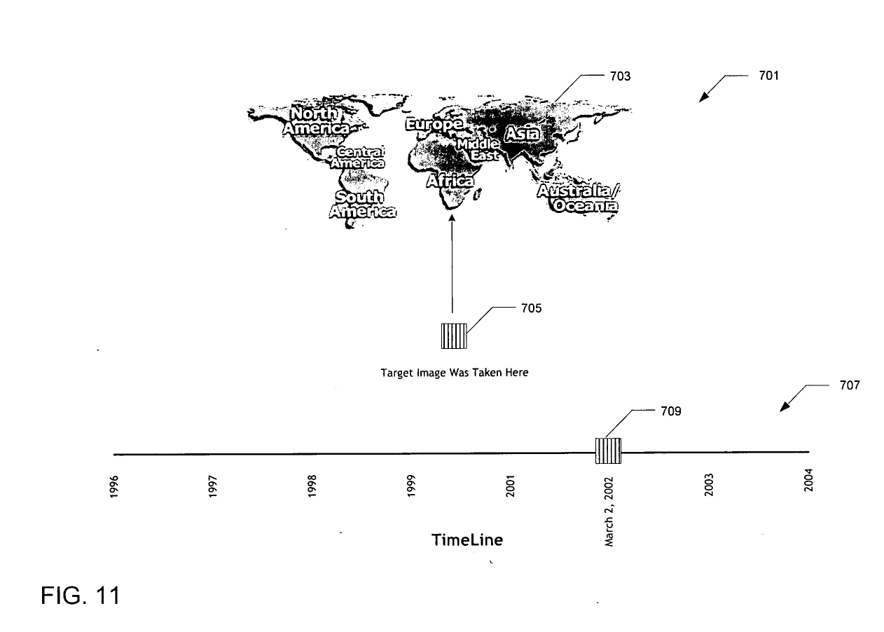

The image is named cancun.jpg and the name of the peer node on which it resides is named shutterbug. By clicking on the coordinates 505, this causes a map to be displayed showing where the image was captured (FIG. 11). As illustrated therein, once a base image 503 is displayed based on position metadata represented by the position 505—for example, as from a GPS device, a user may then also use a separate window 509 to select several options. Included among these options is clicking on a button 511 which commands showing of other images from the same time and position (FIG. 10). The search target can be specified by buttons 513 as being the peer on which the image is displayed, or can be on other peers. The time and position where the image was taken can be specified by button 515, and other peers from the same area as the image can be specified by button 517. Button 519 allows the option of showing other peers from the same area as the peer on which the current image 503 is displayed. This may be based on IP address data. The search range and time line can be selected by search range bar 521 and timeline bar 523.

FIG. 10 illustrates the display 601 which results when buttons 511, 521 and 523 are selected. In display 601, a representation of the world 603 is shown. The location target image 605 is shown as well as other images 607-613 taken at about the same time and position within a selected range and timeline. The distance from the target image 605 is shown for each image 607-613. Similarly, the timeline shows that time 617 corresponds to the target image 605. Time 619 corresponds to image 607, time 621 corresponds to image 609, time 623 corresponds to image 611, and time 625 corresponds to image 613 on the timeline 615.

In FIG. 11, display 701 shows a representation of the world 703. In this case only the timeline 523 was selected and the position of the target image 705 is shown in the representation of the world 703. This diagram is produced by hitting button 515. It uses the setting from 523.

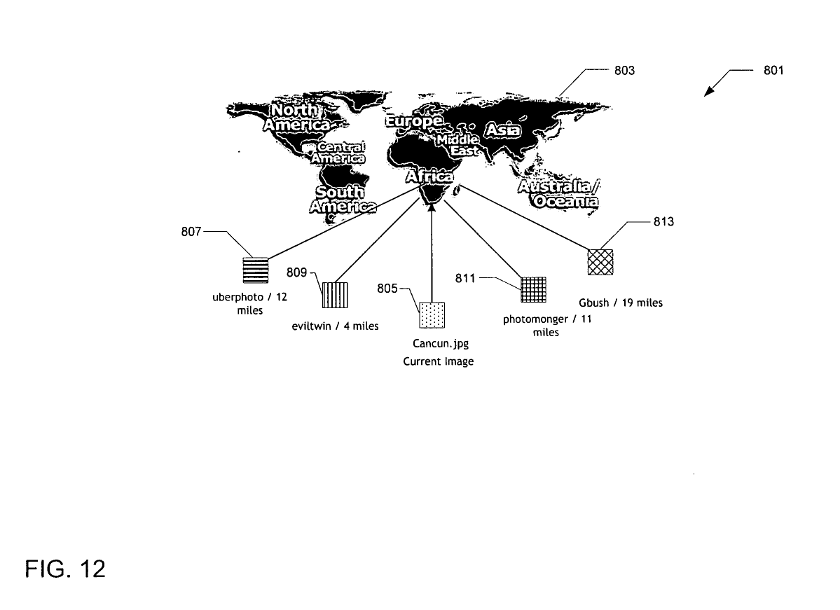

FIG. 12 shows another display 801 with a representation of the world 803. In this case, button 517 to show other peers from the same general position as the image has been selected. The search range button 521 is set for the desired distance. The location of the current image 805 is shown, and peers 807-813 located near the position where the current image 805 was taken are also shown.

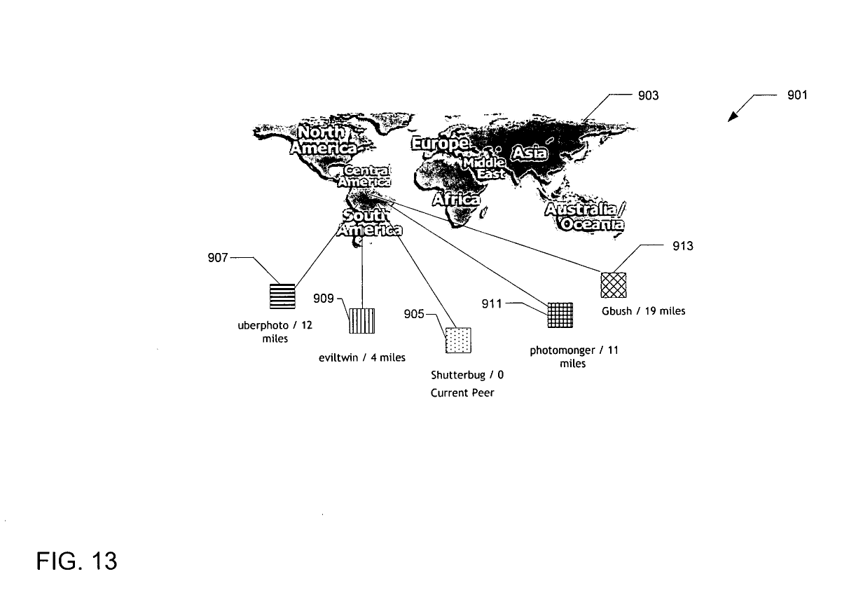

FIG. 13 is yet still a further display 901 with the representation of the world 903 and showing other peers from a position within a distance range from the position of the current peer. In this case, the current peer 905 is shown as a result of having pressed button 519 in FIG. 9. The search range 521 was set to a desired range, and peers 907-913 from approximately the same position are shown.

In a yet still further aspect, the invention can be used to deliver targeted advertisement to searching peers. For example, if a peer searches for New York City, on Sep. 11, 2001, advertisers can contract with the central site 12 peer server 14 to deliver advertising about memorial sites, etc. If the selection is Times Square on New Years Eve, then hotel, theatrical shows and other like advertising may be provided.

It will be appreciated that while the invention has been described in the context of a peer-to-peer network, it is possible to modify the system to operate on a single computer. In this case the selection options relative to other peers is not provided. Nonetheless, in accordance with the invention, searches can be conducted within the same computer in which the target image was found or other images from the same time and place, location and time when the image was taken including specifying the search range and timeline. Targeted advertising can be made part of the programming in a single computer, and the invention need not be limited to a peer network, but can be implemented in a standard system.

FIG. 14 further illustrates the previously discussed various options for applying position data to images. A first option is camera 1001 with a GPS receiver attached. This camera 1001 would be marked first as a source ID 1005 because it is the most accurate source of position data. Resolution 1008 of such a device is within about 50 feet.

A second option is a camera/cell phone 1011 which would be ranked second for image return based on source ID 1015 and has a resolution 1018 of within about 100 feet.

A third option is a capture device 1021 with internet connectivity. Images marked with this device would be ranked third for image return based on source ID 1025 and has a resolution 1025 of within about 50 miles (e.g., city locations).

A fourth option is user input position data (not shown) previously described.

In all cases, a digital image file 1041 is created with image data 1045. The coordinates are entered as GPS coordinates 1048 irrespective of position data source. The image file 1041 will also identify the source 1051 of the GPS data to facilitate return of images in order of accuracy of the data source.

Thus, the system recognizes more than one positioning system. In this manner, position information is more easily obtained without requiring user entry of arbitrary data. By storing the source of the position information in the image, the search can weigh the accuracy of the position for images returned on a case by case basis. In one embodiment, if the user searches on a certain GPS location and finds four images with the same coordinates, it will return the image positioned through GPS first, since GPS is the most accurate of the technologies.

Alternatively, the user can select the order in which sources are tried. The important aspect is that all positioning information is converted to a common or standard format, and that the positioning system used is recorded. In the default, the search function will provide higher weight on positioning information that was obtained through the most accurate methods.

It will also be appreciated by those of ordinary skill that while specific positioning systems have been described, the invention is not limited to those specifically, and as technology develops, more accurate or alternative positioning technologies can be used in place thereof.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for providing a network-based photosharing service, the photosharing service including a central photosharing site having a server, and a plurality of peer nodes each containing digital images, the method comprising:
(a) associating with each image that is to be shared on the photosharing site from the peer nodes, metadata relating to the images, said metadata comprising at least standardized information about the position where the image was created;
(b) sharing the images on the photosharing site while maintaining storage of the images on the respective peer nodes;
(c) in response to the server receiving standardized location search criteria based on the metadata submitted from a first peer node, returning at least one image locator for at least one image matching the search criteria to the first peer node; and
(d) generating on the first peer node a graphical representation of the position being searched with at least one image that matches the search criteria being displayed on the same graphical representation.

2. The method of claim 1, further comprises additional metadata further comprising additional information about the date and time when the at least one image was created.

3. The method of claim 2, further comprising additional metadata related to the position of the peer on which the image is stored based on the IP address of the said peer.

4. The method of claim 1, further comprising dynamically generating on the first peer node advertising about the general position where the image was created.

5. The method of claim 1, wherein said standardized information is Global Positioning System data.

6. The method of claim 5 further comprising additional metadata about location of the peer on which the image is stored based on the IP address of said peer.

7. The method of claim 5, wherein said metadata further comprises time and date of the image.

8. The method of claim 7, further comprising in response to the server receiving a search criteria based on the metadata submitted from a first peer node, returning at least one of the location of peers in proximity to where the image was taken, other images taken in proximity to where the image was taken, and other images taken at about the same time and date the image was taken.

9. The method of claim 8, further comprising dynamically generating on the first peer node advertising related to the general position where the image was created.

10. The method of claim 1, wherein said standardized information is obtained by at least one of: 1) a camera with a GPS receiver attached; 2) a camera/cell phone; 3) a capture device with Internet connectivity; and 4) user input of position data based on standardized map.

11. The method of claim 10, wherein said standardized information is converted to GPS data format irrespective of source.

12. The method of claim 11, wherein the source of the data is indicated as part of the standardized information.

13. The method of claim 12, further comprising returning at least one image locator in order of accuracy of the position information source, with the most accurate returned first.

14. A method for storing and searching images on a single computer containing digital images, the method comprising:
(a) associating with each image that is to be located on the computer, metadata relating to each image, said metadata comprising at least standardized information about the position where the image was created; and
(b) in response to a user inputting a search criteria based on said standardized information, returning at least one image that matches the search criteria; and
(c) generating a graphical representation of the location being searched, while showing each returned image on the representation.

15. The method of claim 14, wherein said metadata further comprises information about the date and time wherein the at least one image was created.

16. The method of claim 14, further comprising dynamically generating advertising related to the general position where the image was created.

17. The method of claim 14, wherein said standardized information is Global Positioning System data.

18. The method of claim 17, wherein said metadata further comprises the time and date the image was created.

19. The method of claim 18, further comprising in response to a user inputting a search criteria, returning at least one other image in proximity to where the image was taken and at least one other image taken at about the same time and date the image was taken.

20. The method of claim 14, wherein said standardized information is obtained by at least one of: 1) a camera with a GPS receiver attached; 2) a camera/cell phone; 3) a capture device with Internet connectivity; and 4) user input of position data based on standardized map.

21. The method of claim 20, wherein said standardized information is converted to GPS data format irrespective of source.

22. The method of claim 21, wherein the source of the data is indicated as part of the standardized information.

23. The method of claim 22, further comprising returning at least one image locator in order of accuracy of the position information source, with the most accurate returned first.

24. The method of claim 19, further comprising dynamically generating on the computer advertising related to the general position where the image was taken.

25. A peer-to-peer photosharing system, comprising:
a plurality of peer nodes, wherein each node stores respective images, and each image has an associated a set of metadata which is standardized information describing the image by at least the position where the image was created;
a central site in communication with the peer nodes over a network, such that when images from each of the peer nodes are to be shared, the image data remains on the respective peer nodes, the central site further configured for functioning to allow a user of one of the peer nodes to submit a search request based on the metadata, and in response, returns at least one image locator matching the search criteria; and
application software on each of the peer nodes for dynamically displaying at least one image by using the image locator to retrieve the at least one image from other peer nodes.

26. The system of claim 25, wherein said metadata further comprises information about the date and time the image was created.

27. The system of claim 26, further comprising additional metadata about location of the peer on which the image is stored based on the IP address of said peer.

28. The system of claim 25, further comprising said computer being programmed for dynamically generating on the first peer node advertising related to the general position where the image was created.

29. The system of claim 25, wherein said standardized information is Global Positioning System data.

30. The system of claim 29, wherein said metadata further comprises information about the date and time when the image was created and about the position of the peer storing the image based on IP address said peer.

31. The system of claim 29, wherein said metadata further comprises time and date data.

32. The system of claim 25, wherein said standardized information has been obtained by at least one of: 1) a camera with a GPS receiver attached; 2) a camera/cell phone; 3) a capture device with Internet connectivity; and 4) user input of position data.

33. The system of claim 32, wherein said standardized information has been converted to GPS data format irrespective of source.

34. The system of claim 33, wherein the source of the data has been indicated as part of the standardized information.

35. The system of claim 34, wherein said application software is configured for displaying the at least one image in order of accuracy of the position information source, with the most accurate displayed first.

36. A system for storing and searching images on a single computer containing digital images, comprising:
a computer storing images, and each image having an associated set of metadata which is standardized information describing the image by at least the position where the image was created;
application software on the computer for allowing a user to submit a search request based on the metadata, and in response, return at least one image locator matching the search criteria; and
application software on the computer for displaying the at least one image matching the search criteria.

37. The system of claim 36, wherein said metadata further comprises information about the date and time when the at least one image was created.

38. The system of claim 36, wherein the computer is programmed for dynamically generating advertising related to the general position where the image was created.

39. The system of claim 36, wherein said standardized information is Global Positioning System data.

40. The system of claim 39, wherein said metadata further comprises the time and date the image was created.

41. The system of claim 36, wherein said standardized information has been obtained by at least one of: 1) a camera with a GPS receiver attached; 2) a camera/cell phone; 3) a capture device with Internet connectivity; and 4) user input of position data.

42. The system of claim 41, wherein said standardized information has been converted to GPS data format irrespective of source.

43. The system of claim 42, wherein the source of the data has been indicated as part of the standardized information.

44. The system of claim 43, wherein said application software is configured for displaying the at least one image in order of accuracy of the position information source, with the most accurate displayed first.
